(19) United States
(12) Patent Application Publication
(10) Pub. No.: US 2007/0131494 A1
(43) Pub. Date: Jun. 14, 2007

(54) Parking brake comprising a cable traction device

(76) Inventors: Christian Baler-Welt, Ober-Ramstadt (DE); Karlheinz Muller, Wurzburg (DE)

Correspondence Address: SIEMENS SCHWEIZ AG;I-47, INTELLECTUAL PROPERTY, ALBISRIEDERSTRASSE 245, ZURICH, CH-8047, CH

(21) Appl. No.: 10/552,386

(22) PCT Filed: Jan. 16, 2004
(86) PCT No.: PCT/EP04/00320

§ 371 Date: Jun. 29, 2006

(30) Foreign Application Priority Data
Apr. 16, 2003 (DE) 103 17 585.7

(51) Int. Cl. F16D 65/14

(52) U.S. Cl. 188/2 D

(57) ABSTRACT

The invention relates to a parking brake, especially for a motor vehicle. Said parking brake (1) comprises a cable traction device in order to actuate the brake and opposite cable deflection by means of at least two deflection rollers (6, 7, 19, 20). The deflection rollers (6, 7, 19, 20) are arranged in such a manner that the connection line can be rotated between the rotational axis of at least two deflection rollers (7, 8, 19, 20) with respect to the drive main axis (18). As a result, a parking brake which is simple to construct and which requires a minimum amount of space is produced. Said parking brake can tighten two brake cables with an essentially equal force in an opposite direction.

The invention relates to a parking brake, in particular for a motor vehicle.

In parking brakes, which are also designated as auxiliary brakes, an operating force is transmitted to a wheel brake via cable traction. In practice, this is achieved by tensioning two brake cables, which are also designated as Bowden pull wires, in parallel or in opposite directions. In order to prevent an unequal braking effect of the braked wheels in this case, it is necessary for the force of the right-hand and left-hand cables to be essentially equal by virtue of a suitable mechanical connection. The condition of equal force must be satisfied, even if both the right-hand and the left-hand side of the brake system require different traction paths at the end of the cable for the same force. This might be caused by different cable lengths to the right-hand and left-hand wheel brakes, for example. As a result of this, different equivalent stiffnesses occur between the individual cables.

The prior art discloses handbrake levers which are arranged inside the interior of the vehicle and use a cable balance as an element for force equalization. Such a parking brake is disclosed in the patent document DE 101 03 295 C1, for example. Such a solution only provides for tightening the brake cable in one direction, however, and therefore a subsequent cable rerouting is required for tensioning the cable in an opposite direction. On one hand, this results in an increased space requirement. On the other hand, the efficiency of the cable system decreases as a result of the required cable deflection.

A further approach to the solution consists in using a spindle system for tensioning the brake cable in an opposite direction. One cable is attached to the spindle itself in this case, while the other cable is connected to the spindle nut as a counterpart. Spindle and spindle nut are mounted in a floating manner in order to ensure an equality of force in this case. Other solutions use a contra-rotating spindle which is mounted in a floating manner and has a right-hand and a left-hand thread in the form of a cable turnbuckle. In addition to the high costs of a spindle compared with other transmission elements, these systems also have the disadvantage of the fixed gearing ratio and the high friction of a spindle-based mechanical system.

In a further approach to the solution, a slotted disk is finally used and the inner wire of the brake cable is passed through said slot. A rotation of this disk, e.g. by a transmission-output shaft, results in a shortening and therefore a tensioning of the Bowden inner wire. However, the extremely high bending radii of the brake cable in the slotted duct of the rotatable disk, which are necessary for reasons of strength, require a significant distance of the pulled cable. Consequently, very high turning moments occur on the driving shaft. As a result of this, it is necessary to include a transmission with very high gearing and an output shaft with large dimensions. A further disadvantage of this solution is the inadequate balance between the right-hand and the left-hand cable traction, since the relatively high sliding friction of the slotted duct allows widely varying cable forces on both sides.

The present invention addresses the problem of creating a parking brake which has a simple structural design and requires little space, said parking brake being capable of tensioning two brake cables with essentially equal force in an opposite direction. This problem is solved by a parking brake having the features recited in claim 1.

The invention is based on the fundamental idea of achieving a tensioning of the brake cables with the aid of a simple design structure including at least two guide pulleys, wherein the connecting line between at least two of the guide pulleys is swiveled in relation to the main axis of the drive. For this purpose, the brake cables are connected at one end in each case to a continuous brake cable. This brake cable is guided around the guide pulleys in the sense of a contra-rotating deflection, preferably by 180°, at least one of said guide pulleys being movably mounted. A space-saving mechanism is provided in this way. As a result of the swiveling of the connecting line between the axes of rotation of at least two guide pulleys, a relative shift of the rollers in relation to each other is achieved, thereby creating a detour for the brake cable, said detour resulting in a tensioning of the brake cable.

Advantageous embodiments of the invention are described in the dependent claims.

The swiveling of the connecting line between the axes of rotation of the guide pulleys is ensured by the special arrangement of the guide pulleys. One of the guide pulleys can be arranged in a fixed location in this case, while the second guide pulley can be moved in a rotary or linear manner (claim 2). Alternatively, both guide pulleys can be arranged in such a way that they can be moved in a rotary or translatory manner (claim 3).

In order to achieve a rotary movement of the guide pulley, this is preferably arranged on a swinging arm (claim 4). Said swinging arm is designed in the form of a swinging lever and is swung with the aid of an output shaft in a further advantageous embodiment of the invention (claim 5). For this purpose, the swinging arm is preferably connected rigidly to the output shaft. The output shaft is driven by a motor, particularly an electromotor, thereby producing an electromotive parking brake. In this case, it is particularly advantageous that only one single drive is required. The significantly more burdensome utilization of a plurality of motors or a separate force regulation via these motors, as required in the prior art in the case of e.g. spindle solutions, is no longer necessary.

In a further embodiment of the invention, it is possible to achieve a minimization of the driving moment in the sense of a balancing of moments by means of a suitable arrangement of the two guide pulleys in relation to each other (claim 6). The balancing of moments can take place partially or fully in the sense of an output shaft which is moment-free in its tightened state.

In an embodiment of the invention, both guide pulleys are arranged on the swinging arm (claim 7). In this case, a first arrangement provides for the pivot of the swinging arm to be arranged approximately midway between the axes of rotation of the guide pulleys (claim 8). By contrast, a further arrangement provides for the pivot of the swinging arm to be arranged asymmetrically to the axes of rotation of the guide pulleys (claim 9).

By virtue of the small number of parts, the claimed parking brake is extremely robust and has low susceptibility to faults. The configuration of the invention in the sense of a minimization of the driving moment makes it possible to reduce the number of transmission stages and also to use smaller transmission shafts as a result of the lower gearing that is required. Consequently, the construction space of the transmission is smaller and therefore a central arrangement in the area of the rear axle is possible in a vehicle.

Moreover, the non-linear gearing of the proposed solution with a balancing of moments can be used advantageously to ensure an essentially constant motor torque with increasing cable forces while the brake is applied. This provides a better and more uniform utilization of the power potential of the motor, thereby resulting in a smaller current requirement for the electromotors that are used. The actuation delays can be shortened at the same time.

As a result of using guide pulleys which are mounted in such a way that they can be rotated about themselves, the friction involved in balancing the force or balancing the path of the two brake cables is minimized. As a result of a cable force equalization which is free of sliding friction and therefore qualitatively valuable, it is possible to dispense with the external cable rerouting that is necessary in the prior art e.g. for systems having a cable balance, said external cable rerouting being adversely affected by sliding friction losses. In comparison with conventional systems, the claimed parking brake therefore exhibits significantly higher efficiency. It is not necessary to compensate for the low efficiency of the cable system by means of an increased power output or force output of the drive as disclosed in the prior art.

The solution according to the invention also provides for working with a variable gearing of the transmission, thereby allowing a particularly flexible adaptation to the various conditions of use.

The geometric arrangement, which includes a balancing of moments, results in a minimization of the transmission loading, thereby resulting in an increase in the service life of the parking brake at the same time.

The parking brake in accordance with the invention, including a balancing of the cable force, can be utilized in all types of vehicles and also in drive systems engineering, materials handling and even in railroad cars, for example.

present invention is described below with reference to exemplary embodiments that are explained in greater detail with the aid of drawings in which functionally identical components are consistently designated using identical reference signs and in which:

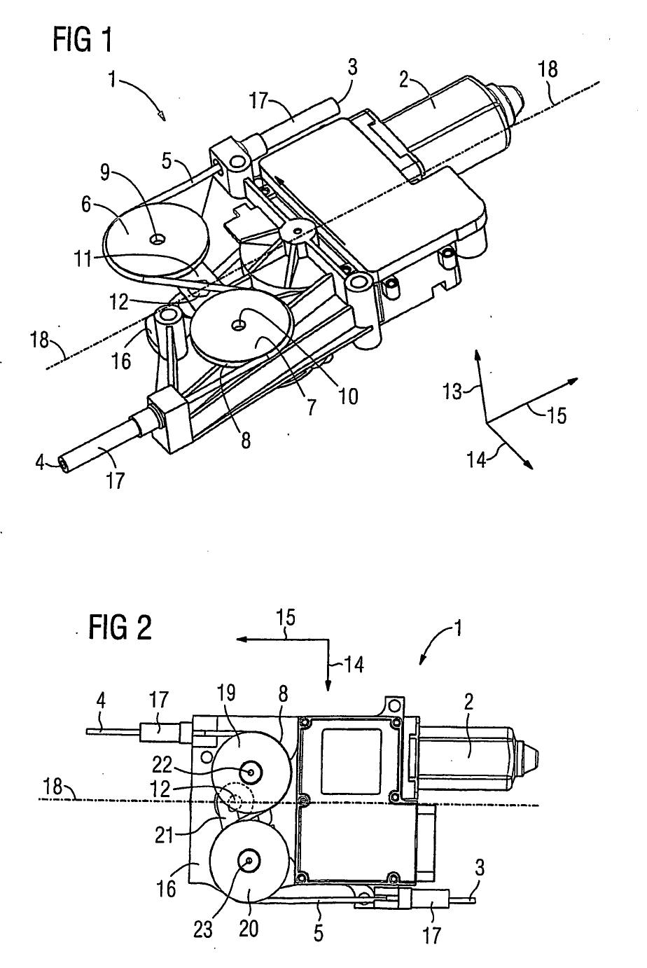

FIG. 1 shows a perspective illustration of a first exemplary embodiment of the parking brake according to the invention,

FIG. 2 shows a schematic illustration of a second exemplary embodiment of the claimed parking brake in a disengaged state,

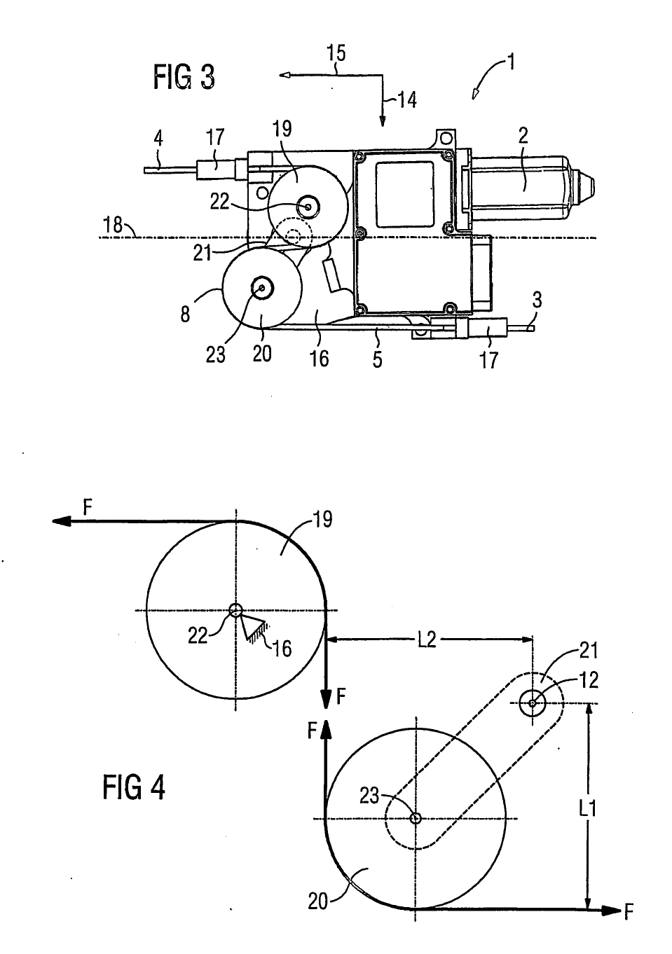

FIG. 3 shows the parking brake from FIG. 2 in a tightened state,

FIG. 4 shows a schematic illustration of a cable pulley mechanism with complete balancing of moments.

A parking brake 1 or auxiliary brake in accordance with the invention is illustrated in FIG. 1. The parking brake 1 comprises an electromotor 2 and an associated assembly for tensioning two brake cables 3, 4 in opposite directions, said brake cables being implemented in the form of Bowden pull wires. The inner wires of the two Bowden pull wires are connected to a continuous inner wire 5. The inner wire 5 is guided around two guide pulleys 6, 7 in the sense of a contra-rotating cable deflection. In this case, the guide pulleys 6, 7 or cable pulleys are designed in the form of cable disks, wherein the inner wire is guided in a circumferential side groove 8. Instead of the cable disks, it is also possible to use correspondingly designed wheel segments for deflecting the cable traction.

The two guide pulleys 6, 7 are rotatably attached on a swinging arm 11 at their centers. In this case, each of the two guide pulleys 6, 7 is arranged at a free end of the swinging arm 11, while the swinging arm 11 itself is attached to a transmission output shaft 12 which is driven by the electromotor 2. The axes of rotation 9, 10 are parallel with the longitudinal axis of the transmission output shaft 12. The pivot of the swinging arm 11, i.e. its attachment to the transmission output shaft 12, is arranged approximately midway between the axes of rotation 9, 10 of the guide pulleys 6, 7, said axes of rotation running through the centers of the guide pulleys 6, 7.

The swinging arm 11 can be swung in a swinging plane which is perpendicular to the longitudinal axis of the transmission output shaft 12, said longitudinal axis extending in the z direction 13. Because the two guide pulleys 6, 7 also lie in the swinging plane which is defined by the transverse and longitudinal direction 14, 15 of the drive housing 16, an extremely compact construction of the housing 16 is possible.

The transmission output shaft 12, the swinging arm 11, the guide pulleys 6, 7 and the inner wire 5 are arranged in the housing 16, whose upper part is not shown in FIG. 1 for reasons of clarity. The two brake cables 3, 4 run as Bowden pull wires in correspondingly provided protective sleeves 17 outside of the housing 16, said protective sleeves being attached to the housing 16.

An operation of the parking brake 1, i.e. an activation of the electromotor 2, causes a rotation of the output shaft 12 and therefore a swinging of the lever arm 11. The connecting line which runs between the axes of rotation of the guide pulleys 6, 7, in the longitudinal direction of the swinging arm is consequently swiveled in relation to the drive main axis 18 which runs through the center of the transmission output shaft 12 and in parallel with the brake cables 3, 4. When the electromotor 2 has a direction of rotational drive in a tightening direction of the parking brake, this results in a tensioning of the inner wire 5. The rotation of the transmission output shaft 12 is thereby transformed into a translatory cable movement.

FIG. 2 shows a second exemplary embodiment of the invention, in which a particularly small turning moment is achieved on the transmission output shaft 12. In this configuration, one of the guide pulleys 19 is statically attached to the housing 16. The other guide pulley 20 is again attached to a swinging lever 21 at its end. The swinging arm 21 is connected at its opposite free end to the transmission output shaft 12 which is driven by the electromotor 2. The inner wire 5 of the brake cables 3, 4 is again guided around two guide pulleys 19, 20 in the sense of a contra-rotating cable deflection, said guide pulleys being rotatably mounted on axes of rotation 22, 23. If the parking brake 1 is now operated in a tightening direction, a swinging of the swinging arm 21 causes a transition from the disengaged state to the tightened state as illustrated in FIG. 3. For this, the lever arm 21 swings the guide pulley 20, said guide pulley being mounted on said lever arm, relative to the static guide pulley 19 in such a way that it produces the required tensioning of the inner wire 5.

In the embodiments cited above, operation of the parking brake 1 counter to the tightening direction slackens the inner wire, 5 and the parking brake can disengage itself.

An arrangement of the cable pulley mechanics as illustrated schematically in FIG. 4 is used for a complete balancing of moments. The moment at the transmission output shaft 12 is equal to zero if the condition L1=L2 is satisfied. This can be achieved by means of a suitable arrangement of the guide pulleys 19, 20 and the swinging arm 21.

1. A parking brake for a motor vehicle, comprising:
an electromotor,
a cable traction device arranged for brake operation; and
a contra-rotating cable arranged to be deflected by means of at least two guide pulleys for two brake cables which act in essentially opposite directions and are continuously connected to each other, said guide pulleys being arranged in such a way that a connecting line between axes of rotation of at least two guide pulleys can be swiveled in relation to the drive main axis.

2. The parking brake according to claim 1, further comiprising a guide pulley which is static and a guide pulley which can be moved in at least one of a rotary and translatory manner.

3. The parking brake according to claim 1, wherein the two guide pulleys are arranged to be moved in at least one of rotary and translatory manner.

4. The parking brake according to claim 1, wherein, at least one of the guide pulleys is arranged on a swinging arm.

5. The parking brake according to claim 4, wherein the swinging arm is arranged to be swung by means of a driven output shaft which is driven by a motor.

6. The parking brake according to claim 5, further comprising an arrangement of guide pulleys and pivoting and swinging arms arranged to reduce a moment on the output shaft.

7. The parking brake according to claim 3, wherein both guide pulleys are arranged on the swinging arm.

8. The parking brake according to claim 7, wherein the swinging arm is arranged to pivot approximately midway between the axes of rotation of the guide pulleys.

9. The parking brake according to claim 7, wherein the swinging arm is arrangd to pivot symmetrically to an axes of rotation of the guide pulleys.

10. The parking brake according to claim 5, wherein the motor is an electromotor.
